(19) United States
(12) Patent Application Publication
(10) Pub. No.: US 2004/0245514 A1
(43) Pub. Date: Dec. 9, 2004

(54) Wooden beam end shielding apparatus and method

(76) Inventor: Herman Demetrius Green, Culver City, CA (US)

Correspondence Address: ROBERT J. SCHAAP, Suite 188, 21241 Ventura Boulevard, Woodland Hills, CA, 91364, US

(21) Appl. No.: 10/861,578

(22) Filed: Jun. 4, 2004

Related U.S. Application Data
(60) Provisional application No. 60/475,754, filed on Jun. 5, 2003.

(51) Int. Cl. A01K 3/00

(52) U.S. Cl. 256/65.05

(57) ABSTRACT

An apparatus for covering the exposed ends of beams as, for example, beams used in fence construction. The apparatus is present in the form of a sleeve or a cap, sized to fit over the ends of the beams, to provide protection against weathering.

### RELATED APPLICATIONS

This application is based on and claims for priority the filing date of my U.S. Provisional Patent application Ser. No. 60/475,754, filed Jun. 5, 2003, for Method and Apparatus for Protecting the Edge of Wooden Rails.

### BACKGROUND OF THE INVENTION

1. Field of the Invention

The present invention primarily relates to a wooden beam shielding apparatus for shielding the sawn ends of wood beams as, for example, fence rails used in a wooden fence construction and, more particularly, to a highly effective and low cost system including components which are easily and readily installable.

2. Brief Description of Related Art

Although there have been numerous attempts to protect wood from the effects of weathering, these attempts primarily rely upon treatment of the entire piece of wood. While this is desirable for many applications, it is also time-consuming, costly and thereby increases the overall cost of the wooden pieces. Moreover, in many cases, protection of a piece of wood as, for example, a wooden beam is not necessary, particularly when it is going to be painted.

The problem of protecting the ends of wooden beams which serve as rails in a fence construction, for example, is a particularly pronounced problem inasmuch as the vast portion of the fence is typically painted or sealed. However, there is a need for some means to protect the ends of the beams and those portions adjacent to the ends of the beams against weathering and the like. Again, all previous treatments have primarily relied upon chemical type protection systems. In most cases, the chemical is a type of creosote which is impregnated into the wood and is designed to protect against weathering and, for that matter, even burrowing insects.

It is actually unnecessary to provide this chemical protection when the wood itself is to be painted or sealed with another type of coating material. However, in the case of wooden rails and fences, the end portions may never be painted and, if they are painted, they are usually inadequately painted. Special care must be taken in painting the end portions of a wooden rail as opposed to the body of the rail. Otherwise, effective sealing is not accomplished.

The same holds true where wooden beams are used in other applications. For example, in housing construction and other building construction the so-called “open beam” form of construction is employed. In this case, a beam which holds up a portion of the structure as, for example, the roof, may extend across a portion of the inside of the structure and project outwardly at ends thereof. However, in this case the ends of the open beam are typically not properly sealed, even when painted.

It would be desirable to provide some apparatus which effectively mechanically seals the ends of wooden beams and which does not necessarily rely upon chemical impregnation of the wood.

### OBJECTS OF THE INVENTION

It is, therefore, one of the primary objects of the present invention to provide an apparatus for mechanically fitting over or around end portions of wooden beams to effectively seal the wooden beams against weathering and which thereby avoids the need for chemical impregnation thereof.

It is another object of the present invention to provide an apparatus of the type stated which is highly effective for use in wooden beams which function as rails, e.g. fence rails, and the like and which would otherwise be exposed to weathering if not properly sealed.

It is a further object of the present invention to provide a wooden beam sealing apparatus of the type stated which can be used in a wide variety of wooden frame constructions and which is adaptable to each of these frame constructions in which an end of a wooden beam in that construction would otherwise be exposed to weathering.

It is an additional object of the present invention to provide an apparatus for sealing the ends of wooden beams which is easily usable by relatively unskilled personnel and which is highly effective when applied to the end regions of wooden beams.

It is another salient object of the present invention to provide a method for sealing the ends of wooden beams by application of metal pieces which can extend about portions of an end section of the beam for effectively covering same.

With the above and other objects in view, my invention resides in the novel features of form, construction, arrangement and combination of parts and components presently described and pointed out in the claims.

### SUMMARY OF THE INVENTION

Apparatus for sealing the end portions of wooden beams as, for example, horizontally located wooden beams, which would otherwise have exposed end portions thereof. This is particularly true and effectively advantageous in protecting the ends of wooden beams which have been freshly cut. These beams are otherwise highly susceptible to weathering and therefore rapid deterioration.

The present invention is highly useful in protecting wooden beams in a variety of constructions. However, one of the constructions in which the apparatus is particularly effective is in fences. Thus, for purposes of illustrating and describing the present invention, the apparatus will be shown as being used in connection with a fence. However, it is to be understood that the apparatus is effective in other types of constructions.

In a wooden fence, the rails which are generally the horizontally extending pieces spanning a pair of vertically arranged posts, are usually freshly cut pieces of wood which have exposed ends. In most fence constructions, the exact size of the rail is not necessarily known until the fence is being constructed. Consequently, wooden boards having a length greater than the desired length of the rails are usually cut to the desired size. In this case, the apparatus of the invention is highly effective.

The apparatus of the invention comprises a sleeve which is adapted to fit over the end region of a freshly cut beam in order to protect the same. This end region may be arranged to abut against a post where the end of the beam is thereupon largely protected from weathering. However, the sleeve will preclude a substantial amount of rainwater and the like from entering the region between the vertically arranged posts and the horizontally extending rail.

The sleeve is preferably rectangularly shaped to fit the end of a rectangularly shaped piece of wood. It is also provided with fastening means enabling easy securement to the end portion of the beam.

Another shielding apparatus forming part of the present invention is provided in the nature of a cap. In this case, there is a four sided exterior wall which is generally rectangularly shaped and which is also provided with a flat end plate. This device is adapted to fit over and be secured to the end of a rail which would otherwise be exposed. Here again, fastening means are provided with the end cap to enable securement to the rail or other wooden beam.

The shielding apparatus of the invention is highly effective to preclude rainwater and water from other sources from entering the exposed ends of the beams which would thereby cause premature decay. When the decay begins to occur, the wood itself begins to crack and even rot. If the end was not properly sealed, even by chemical impregnation, then the wooden beam will, in a period of time, begin to rapidly deteriorate. Very frequently in fence constructions, after the horizontal rail is applied to vertically spaced apart posts and even when the fence construction is painted, little or no care is taken to attempt to ensure that paint covers and is thoroughly impregnated into the end of a wooden beam. This is particularly true when that end is abutted against another piece of wood. Water can become entrapped between two abutted pieces of wood and thereby become absorbed by a piece of wood causing the latter to prematurely rot.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a perspective view of one form of shielding apparatus, in the nature of a cap, which is adapted to be secured to an end of a wooden beam;

FIG. 2 is a side elevational view of the cap of FIG. 1;

FIG. 3 is a top plan view of the cap of FIG. 1;

FIG. 4 is a perspective view of a modified form of sleeve adapted to extend over an end of a wooden beam in accordance with the present invention;

FIG. 5 is a side elevational view of the sleeve of FIG. 4;

FIG. 6 is a perspective view of a shielding apparatus in the nature of a C-shaped collar adapted for attachment to the end of a beam in accordance with the present invention; and

FIG. 7 is a perspective view of a fence construction showing the use of the shielding apparatus of the invention in various embodiments used on that fence construction.

### DETAILED DESCRIPTION OF A PREFERRED EMBODIMENT

Referring now in more detail and by reference characters to the drawings which illustrate several practical embodiments of the present invention, 10 designates a shielding apparatus in the nature of an end cap for disposition over the end of a wooden beam. In the various embodiments of the apparatus as shown, it can be observed that they are highly effectively used in connection with protecting the ends of wooden beams in a wooden fence construction. However, it should also be understood that they are effective in protecting wooden beams in essentially any construction. Thus, for exposed wooden beams of open beam roof constructions and the like, it is desirable to protect the ends of these beams against deterioration.

The shielding apparatus, which essentially functions as a protective device, is desirable for use on wooden beams where the ends of the beams are exposed, particularly to air entrained water and the like and even potentially to some UV degradation. These devices are frequently made from metal, such as aluminum or even steel. However, they can be readily formed from plastic materials, such as polyethylene, polypropylene and the like. If desired, they can even be formed of reinforced composite materials.

In a first embodiment of the invention, the protective device 10 is formed in the nature of an end cap having a top wall 20, a bottom wall 22, a pair of side walls 24 and 26 and a back wall 28 leaving an open front end 30. In this way, the device actually operates in the manner of a cap and literally fits over the end of the beam. This type of protective device is highly effective where the beam extends beyond any other type of frame structure and is not designed to abut against another wooden member or, for that matter, any other structural member. In this way, the end of the beam is protected both from atmospheric water and from UV degradation.

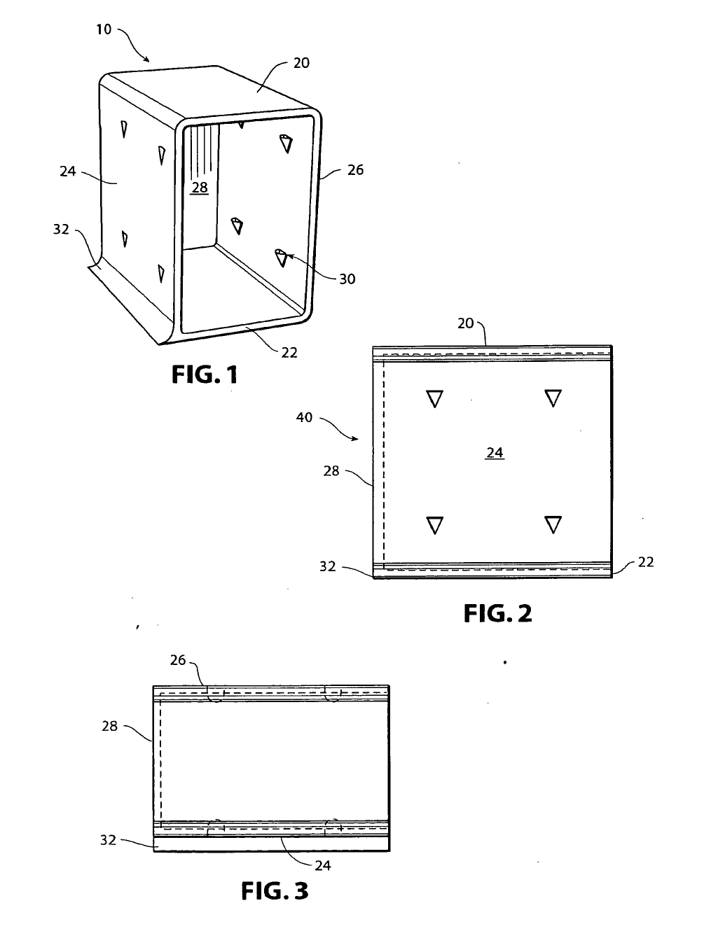

In the embodiment of the invention as illustrated in FIGS. 1-3, it can be observed that there are inwardly projecting points or protrusions 30 which have relatively sharp edges or points to literally bite into the surface of the wood and thereby physically engage the protective device on the end of the wooden beam. It should be understood, however, that other forms of fastening means or the protective devices could be used.

One of the side walls, such as the side wall 24, is provided at its lower end with an outwardly curving lip 32. This lip is designed to enable the runoff of any rainwater or water from any other source away from the beam. In this way, water is potentially precluded from running between an edge of one beam abutted against a vertically disposed column.

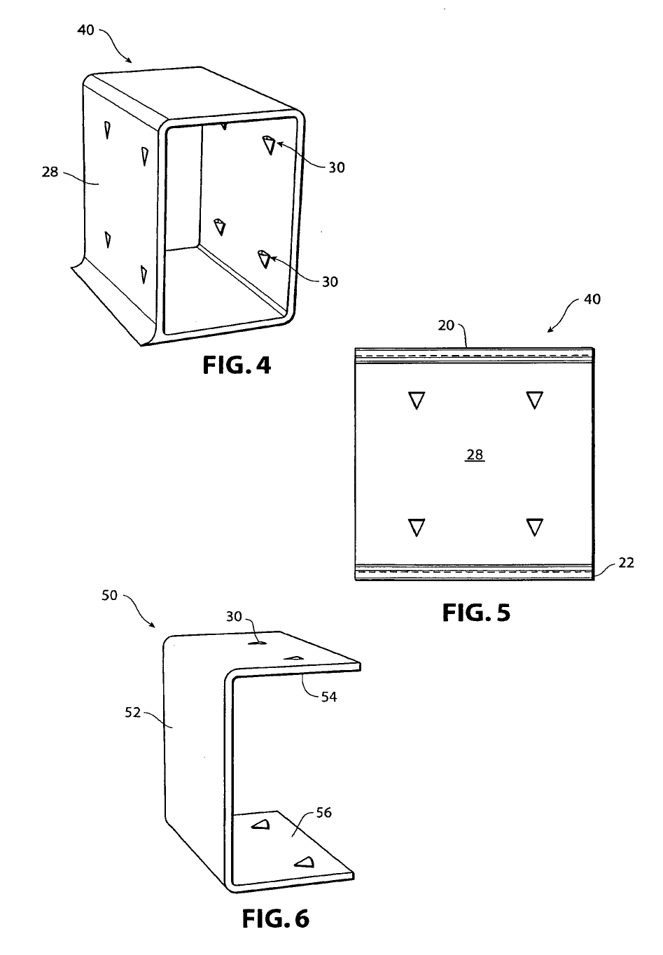

FIG. 4 shows a modified form of protective device 40 for use on the end of a wooden beam and which is similar to the protective device 10 of FIG. 1, except that the protective device 40 does not have a rear wall 28. In other words, the protective device 40 has merely the four walls without the back wall, as shown in FIG. 1. Beyond this, the protective device 40, as shown in FIG. 4, is substantially similar to the previous protective device. In this respect, like reference numerals will be used to designate like components that appear in the embodiment 10 of FIGS. 1-3.

FIG. 6 illustrates yet another embodiment of the invention in which the protective device is in the form of a somewhat C-shaped bracket 50 having only a flat wall 52 connected to a pair of end walls 54 and 56. In this case, the protective device 50 would be adapted to extend over the top surface of a wooden beam with the two end walls 54 and 56 extending downwardly along the sides thereof. Thus, if the beam were a 2″×4″ beam which was laid on its flat side, then the wall 52 would engage the flat surface of the beam in the 4″, direction and the two end walls 54 and 56 would engage the two side surfaces, such as the 2″ side surfaces. In like manner, the protective device 50 is similarly provided with the projections or points 30.

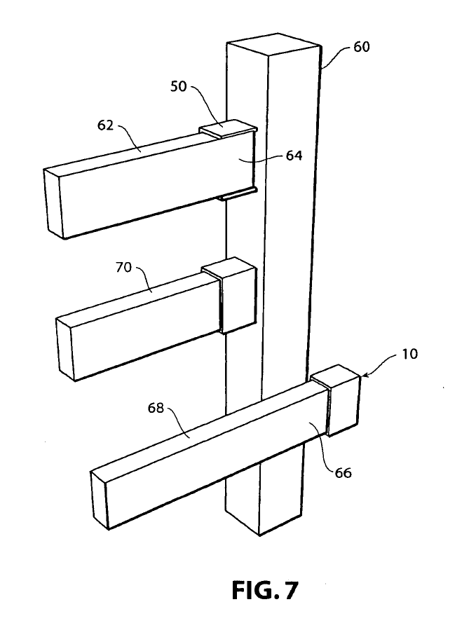

FIG. 7 illustrates the use of the device in the construction of a fence having a plurality of spaced apart vertically disposed columns 60, such as a 4″×4″ post 60. Extending between a pair of the columns are a pair of 2″×4″ beams 62 and which have ends abutted against one of the flat surfaces of the columns 60. In this case, any of the aforesaid protective devices, such as the protective device 50, could be used. Moreover, in this case it can be observed that it is not necessary to protect the bottom surface but that it is necessary to protect three sides of the beam near the cut end. That beam 62 has a cut end 64 which, in this case, is abutted against the column 60. Nevertheless, with the protective device 50 in place, water cannot readily flow between the column 60 and the beam 62 thereby protecting same.

The fence construction as shown may also have another beam 66 which is abutted against one flat surface of the column 60 but has a portion 68 extending beyond the column. In this case, a protective device, such as the protective device 10, may be extended over that end of the beam.

In the case of a typical fence construction, there is usually another and lower cross beam 70 located beneath the cross beam 62. In any event and in any construction, the protective device of the invention is placed over the opposite ends of each of these beams or rails. The outwardly projecting curved portion 32 is a trumpet-angled flange designed to direct excess moisture away from the column to which the beam is secured.

Thus, there has been illustrated and described a unique and novel wooden beam end shielding apparatus and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what I desire to claim and secure by Letters Patent is:

1. A wooden beam protective device for protecting an end of a wooden beam having a plurality of elongate flat surfaces and an end face extending between the said flat surfaces in generally perpendicular relationship thereto, said device comprising:
a) a plurality of elongate relatively flat walls which are sized and arranged to engage certain of the flat surfaces of said beam; and
b) edges on certain of said flat walls of said device which generally lie in the same plane as the end surface of the beam, or slightly spaced therefrom and being located on the beam in such a position so as to protect the end face of the beam from environmental exposure.

2. The wooden beam protective device of claim 1 further characterized in that said device has three elongate walls connected in somewhat of a U-shaped arrangement and designed to cover a top surface of a beam and a pair of perpendicular side surfaces of that beam.

3. The wooden beam protective device of claim 1 further characterized in that said device comprises four relatively flat elongate walls and which are arranged in somewhat of a quadrilateral arrangement to extend over the end portions of four surfaces of a beam.

4. The wooden beam protective device of claim 3 further characterized in that an end plate extends over an open end of said quadrilaterally shaped walls so that the structure forms a cap adapted to act as a cap on the open end of a beam.

5. The wooden beam protective device of claim 1 further characterized in that at least one of said walls is provided with an attachment means adapted for engagement with and retentive disposition on an end portion of a wooden beam.

6. The wooden beam protective device of claim 5 further characterized in that said attachment means are inwardly projecting prongs which are adapted to stick into the wooden beam and thereby become adhered to the wooden beam.

7. A method of protecting an end of a wooden beam against environmental exposure from at least rainwater and UV degradation, said method comprising:
locating a protective device about at least three surfaces of a wooden beam adjacent an end portion thereof in such manner that the beam is at least partially insulated from exposure to rainwater and UV degradation.

8. The method of claim 7 further characterized in that said method comprises abutting the beam to be protected against another beam in generally perpendicular relationship thereto so that the end of the beam to be protected is not exposed and reducing the possibility of rainwater collecting between the end of the beam and the beam with which it is engaged.

9. The method of claim 7 further characterized in that said method comprises locating said protective device about three orthagonally located surfaces of said beam.

10. The method of claim 7 further characterized in that said method comprises locating the protective device about four orthagonally located surfaces of a beam.

11. The method of claim 7 further characterized in that said method comprises also extending a wall forming part of the protective device over an end surface of said beam.

12. A wood construction in which wooden beams are used as part of the wood construction and where there is a need for protecting the wooden structure from degradation through environmental exposure, said construction comprising:
a) at least one vertically arranged upstanding column;
b) a generally horizontally arranged wooden beam secured to or otherwise abutting with said upstanding column as part of said construction;
c) a beam protective device secured to only said beam and extending around a portion of the beam including at least an upper surface and two vertically arranged side surfaces of said beam; and
d) means for securing said protective device to the beam positioned to reduce the possibility of rainwater from engaging the end of the beam.

13. The wood construction of claim 12 further characterized in that the end of said beam is engaged with a surface of the upstanding column and the protective device extends around the portion of the beam adjacent to said end surface.

14. The wood construction of claim 12 further characterized in that said protective device extends about four surfaces of said beam.
